(19) United States
(12) Patent Application Publication
(10) Pub. No.: US 2016/0162830 A1
(43) Pub. Date: Jun. 9, 2016

(54) INVENTORY MANAGEMENT BASED ON AUTOMATICALLY GENERATING RECOMMENDATIONS

(71) Applicant: SURESH DEVAIAH, Bangalore (IN)

(72) Inventor: SURESH DEVAIAH, Bangalore (IN)

(21) Appl. No.: 14/561,191

(22) Filed: Dec. 4, 2014

(51) Int. Cl. G06Q 10/08; G06Q 30/06

(52) U.S. Cl. CPC G06Q 10/087; G06Q 30/0635; G06Q 30/0605

(57) ABSTRACT

Various embodiments of systems and methods to automatically generating recommendations for managing an inventory of a product are described herein. In one aspect, sensor data is received from one or more sensors, and demonstration data is received from one or more product demonstrators. The sensor data represents a number of customers that viewed the product displayed in a shopping area of a business entity, and the demonstration data represents a number of times the product is demonstrated in the shopping area. In another aspect, based on the sensor data and the demonstration data, an interest score for the product is determined Further, in yet another aspect, based on the determined interest score and a quantity of the product sold by the business entity within the period of time, the recommendations are automatically generated and provided to the business entity for managing the inventory of the product.

### BACKGROUND

Generally, business entities that sell products manage inventories of the products. The primary objective in managing an inventory of a product is to increase profitability by maintaining the inventory of the product at an appropriate level. Any over inventory or under inventory of the product may cause financial impact to the business as well as negatively affect business development.

Inventory management of a product is approached in different ways. Typically, a person is given the responsibility of monitoring the inventory of the product, and preparing purchase requests when the inventory of the product diminishes. Such a manual inventory management relies heavily on personal actions which may be prone to human error. Further, the manual inventory management may be time-consuming activity.

Therefore, automated inventory management systems are often used to manage inventories of products. For example, an automated inventory management system may utilize barcode scanners or other electronic identifiers to track outgoing and incoming products in the inventory. Usually, such automated inventory management systems determine future demand of the products based on historical sales data of the products, on past demand of the products, etc. Based on the determined future demand, purchase orders are prepared for purchasing the products to replenish the inventory of the products. However, the customers' interest in the products is not accounted for in determining the future demand of the product. In turn, this makes it difficult for effectively managing the inventory of the products.

### BRIEF DESCRIPTION OF THE DRAWINGS

The claim set forth the embodiments with particularity. The embodiments are illustrated by way of examples, and not by way of limitation in the figures of the accompanying drawings in which like references indicate similar elements. The embodiments, together with its advantages, may be best understood from the following detailed description taken in conjunction with the accompanying drawings.

FIG. 1A to FIG. 1C are the flow diagrams illustrating a process of automatically generating recommendations to manage an inventory of a product, according to an embodiment.

FIG. 2 is a flow diagram illustrating a process of automatically generating and rendering recommendations to a customer viewing a wearable product, and to a business entity, to manage an inventory of the wearable product, according to an embodiment.

FIG. 3A and FIG. 3B are charts illustrating an exemplary interest maps generated for product A of a business entity A, and product A of a business entity B, respectively, according to an embodiment.

FIG. 4 is a block diagram of an exemplary system for automatically generating recommendations to manage an inventory of a product, according to an embodiment.

FIG. 5 is a block diagram illustrating a computing environment, according to an embodiment.

### DETAILED DESCRIPTION

Various embodiments of system and methods of managing an inventory of a product based on automatically generating recommendations are described herein. In an embodiment, the recommendations are automatically generated based on customers' interest in the product, and a quantity of the product sold by the business entity within a period of time. The product may he displayed in a shopping area of the business entity. In an aspect, the customers' interest in the product may be determined by identifying: a number of customers that viewed the product within the period of time, and a number of times the product is demonstrated in the shopping area within the period of time. In an embodiment, the generated recommendations are provided to the business entity for managing the inventory of the product. In the following description, numerous specific details are set forth to provide a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment”, “an embodiment”, and similar phrases, means that a particular feature, structure, or characteristic described in connection with the embodiment is included in at least one embodiment of the one or more embodiments. Thus, the appearances of these phrases in various places throughout this specification are not necessarily all referring to the same embodiment. Furthermore, the particular features, structures, or characteristics may be combined in any suitable manner in one or more embodiments.

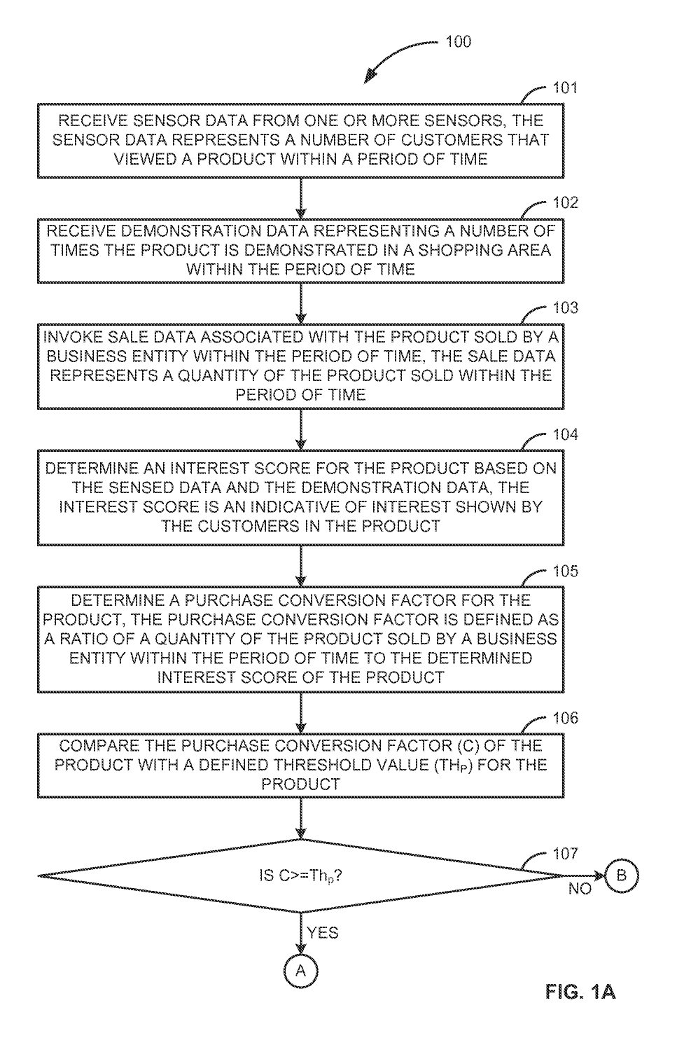

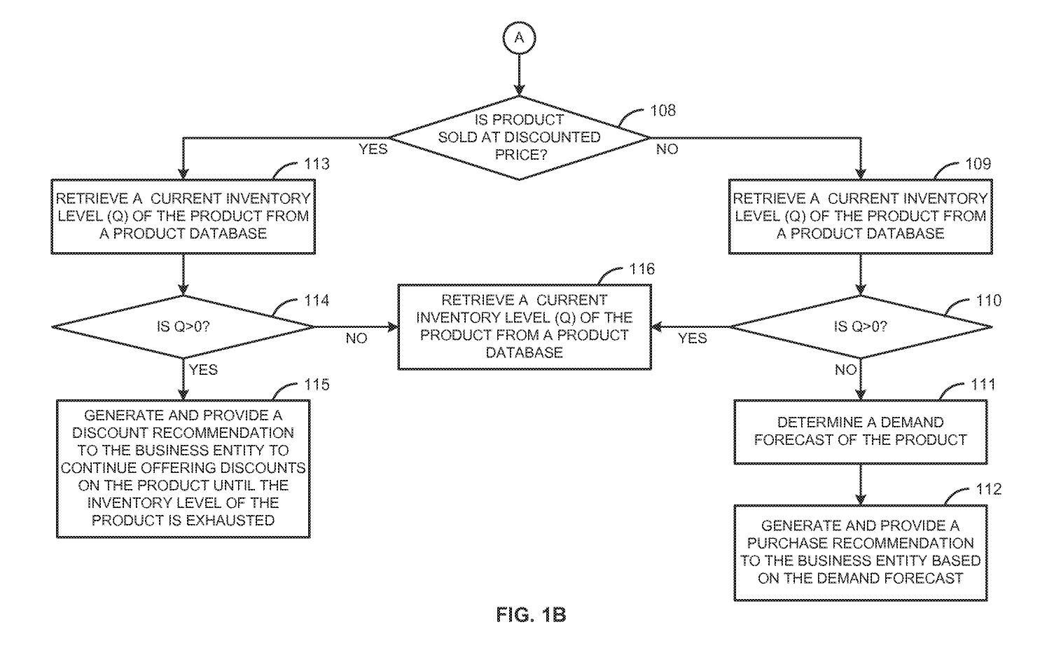

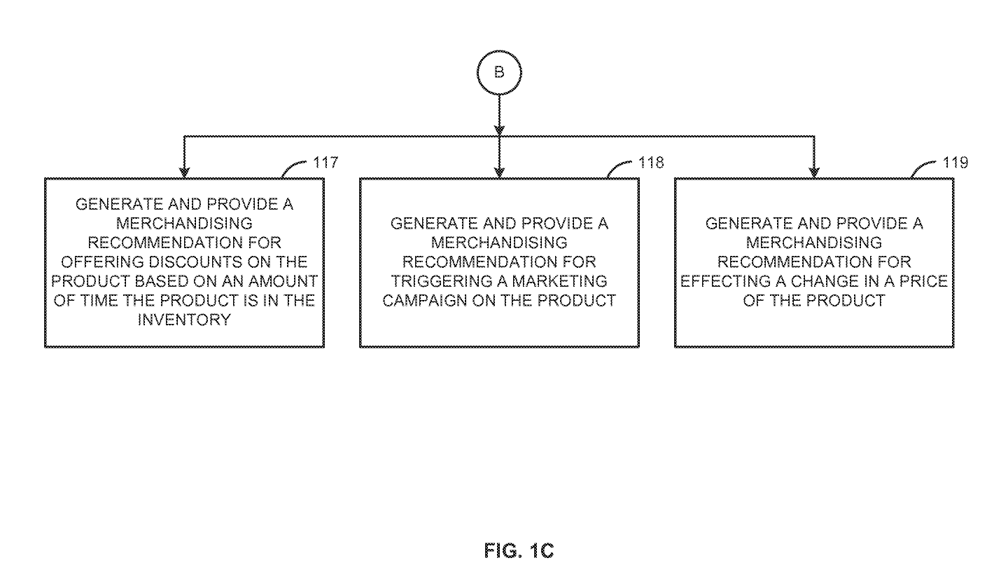

FIG. 1A to FIG. 1C are flow diagrams illustrating process 100 to automatically generating recommendations to manage an inventory of a product, according to an embodiment. At 101, sensor data is received from one or more sensors. The sensor data represents a number of customers that viewed the product displayed in a shopping area of a business entity within a period of time. For example, the period of time may be an hour, a business day, or a sale period. The business entity may be a retail outlet, a chain store, a boutique, etc. The one or more sensors may be force sensors, load sensors, pressure sensors, touch sensors, proximity sensors, optical sensors, heat map sensors, etc.

In an embodiment, the one or more sensors may be located in a certain region of the shopping area of the business entity. For example, sensors such as optical sensors and proximity sensors may be placed along the line of vision of the product and the customer. In another example, sensors such as heat map sensors may be installed on floors or ceilings to literally track a “heat map” of where customers are present in a shopping area of a retail outlet. Heat maps can be constructed to watch footfall patterns of the customers. Yet, in another example, sensors such as pressure sensors and force sensors may be installed on or under the floor of a retail outlet.

In an embodiment, the one or more sensors may detect the presence of customers in a viewing region relative to the product. The term “viewing region” as used herein refers to a spatial location defined in relation to the product being viewed. For example, for a particular product placed on a shelf of a retail outlet, the region in front of the particular product having defined boundaries is the viewing region relative to that particular product. The one or more sensors may be tuned or adapted to detect the presence of a customer in a particular viewing region and correlate this information to the product associated with the particular viewing region.

According to one or more embodiments, the sensor data (indicating customers' presence) is representative of the number of customers that viewed the product associated with the viewing region, within the period of time. In an embodiment, the number of customers that viewed the product within the period of time is identified by a processor of a computing device. The output of the one or more sensors (i.e., the detection signal) may be conununicated to the computing device through a data communication network. The data communication network may include an electronic communications network, such as the Internet, a local area network (“LAN”), a wide area (“WAN”), a wireless local area network (“WLAN”) a cellular communications network or the like. In an embodiment, the computing device may be a server. When a customer is in the viewing region, the one or more sensors may detect the presence of the customer and produce the detection signal. A time period of the detection signal indicates the time spent by the customer in the viewing region. The time period of the detection signal is compared with a defined time. Based on the comparison, a footfall counter of the computing device is incremented, e.g., if the time period of the detection signal is greater than or equal to the defined time. In an embodiment, the business entity may be provided with an option to input the defined time. The footfall counter value at the end of the time period represents the number of the customers that viewed the product within the period of time.

At 102, demonstration data is received from one or more product demonstrators. The demonstration data represent a number of times the product is demonstrated by the one or more product demonstrators to the customers that requested a product demonstration in the shopping area within the period of time. The one or more product demonstrators refer to personnel or automation that demonstrates how a product, equipment, device, etc., works. During the product demonstration, the one or more product demonstrators may show the product capabilities, and follow up by responding to questions or concerns the customers may have about the product. Product demonstrations may vary based on a nature of the product. For example, a food product is demonstrated by distributing samples of the food product to the customers to taste the particular food product. Further, the product demonstrations may also include distributing brochures, mammals, pamphlets, and the like, related to the product, to the customers, e.g., upon request from the customers. In an embodiment, upon demonstrating the product to the customers, the one or more product demonstrators may communicate the information related to the product demonstration to the server, for example, using a demonstration application pre-loaded on a portable electronic device. The portable electronic device may be a laptop computer, a tablet computer, a mobile phone, a personal digital assistant (PDA), a smart phone, a pager, etc. The information related to the product demonstration includes, but not limited to, the product identification (ID) data, time at which demonstration of the product is performed, etc. The demonstration application is configured to communicate with the server through a data communication network such as, but not limited to, the Internet. In an embodiment, the server may be an internal server located within the premises of the business entity. In another embodiment, the server may be located remotely and may connect and communicate with the portable electronic device through the data communication network. The server may include or be connected to a database configured to store information related to the product demonstration received from the demonstration application.

In another embodiment, the one or more product demonstrators may request the server for the demonstration application, and in response the server may allow the one or more product demonstrators to download and launch the demonstration application on portable electronic devices operated by the one or more product demonstrators.

In an embodiment, the one or more product demonstrators begin entering the information related to the product demonstration into the demonstration application by entering a login identification of the one or more product demonstrators on a login screen of the demonstration application. The login process may request a username and a password. The one or more product demonstrators may be authenticated at the server by comparing the stored credentials on the server with the entered login identification details by the one or snore product demonstrators. Once the one or snore product demonstrators are identified, a user interface of the demonstration application is displayed on the portable electronic devices and allows the one or more product demonstrators to select the identification data of the product that is demonstrated from a list of product ID's displayed on the user interface. In an embodiment, the user interface allows the one or more product demonstrators to manually enter the ID of the product that is demonstrated in a provided field. Further, the one or more product demonstrators may input the time at which the product is demonstrated. The information related to the product demonstration is transmitted to the server and stored in the database. In response to receiving the demonstration information related to the product, a counter in the server may be incremented. The counter value at the end of time period represents the number of times the product has been demonstrated within the period of time In another embodiment, the demonstration data may be collected from the one or more product demonstrators using radio frequency identification (RFID) systems, wearable sensors, etc.

At 103, sales data associated with the product sold by the business entity is invoked from a sales record system of the business entity. The sales record system may include a plurality of Point-of-Sale (POS) terminals coupled to a sales record computer. The POS terminals may be configured to identify and record the sales data such as product ID, quantity, cost, discount if any, etc., thereby generating a sales record. The sales record is sent to the computing device as the sales data. The sales data may include the following, but not limited to: a name of the business entity, a timestamp corresponding to the time at which the product was sold, price of the product, a quantity of the purchased products, product ID, etc. The quantity of the product sold by the business entity within the period of time could be identified from the sales data based on the ID of the product and the timestamp corresponding to the time at which the product was sold.

At 104, an interest score for the product is determined in an embodiment, the interest score for the product is determined based on the sensor data and the demonstration data. The interest score for the product is an indicative of interest shown by the customers towards the product. In an embodiment, the sensor data and the demonstration data may be weighted to indicate relative importance of the sensor data and the demonstration data in determining the interest score. For example, if the number of customers that viewed the product (e.g., sensor data) is greater than the number of times the product is demonstrated to the customers demonstration data), the sensor data may be weighted lighter than the demonstration data in determining the interest score.

In an embodiment, a first weighting factor may be assigned to the sensor data and a second weighting factor may be assigned to the demonstration data. Upon assigning the first weighting factor and the second weighting factor to the sensor data and the demonstration data, respectively, weighted sensor data and weighted demonstration data may be computed. In an embodiment, the weighted sensor data is computed as a product of the sensor data and the first weighting factor, and the weighted demonstration data is computed as a product of the demonstration data and the second weighting factor. The interest score for the product may be determined by adding the weighted sensed data and the weighted demonstration data. In an embodiment, the first weighting factor and the second weighting factor may be in the range of 0 to 1, and the sum of the first weighting factor and the second weighting factor may be 1. For example, if the first weighting factor is 0.6, then the second weighting factor is 0.4. In another embodiment, the first weighting factor and the second weighting factor may be equal. For example, if the first weighting factor is 0.5, then the second weighting factor is 0.5. In some embodiments, the first weighting factor and the second weighting factor may be different. For example, the first weighting factor and the second weighting factor may be assigned proportional to the number of customers that viewed the product and the number of times the product is demonstrated. For example, if number of customers that viewed the product is eight, and number of times the product is demonstrated is two, then the first weighting factor is 0,8 and the second weighting factor is 0.2.

At 105, a purchase conversion factor (C) for the product is determined. In an embodiment, the purchase conversion factor (C) for the product is defined as a ratio of the quantity of the product sold by the business entity within the period of time to the determined interest score for the product. The purchase conversion factor for the product is a measure of conversion of the customers' interest in the product to the sales of the product.

At 106, the purchase conversion factor (C) for the product is compared with a threshold value (Thₚ) defined for the product. In an embodiment, the threshold value (Thₚ) for the product is defined based on a type of the product and a cost of the product. In an embodiment, the business entity may be allowed to input the threshold value for the product. The threshold value (Thₚ) for the product may be different or same as threshold value for one or more other products.

At 107, a check may he performed to identify whether the purchase conversion factor (C) for the product is greater than or equal to the threshold value (Thₚ) defined for the product. At 108 (FIG. 1B), in an embodiment, upon identifying that the purchase conversion factor (C) for the product is greater than or equal to the threshold value (Thₚ) defined for the product, a check may be performed to identify whether the product is sold by the business entity at a discounted price or at a regular price. In an embodiment, the sales data of the product may be used to identify whether the product is sold at the discounted price or at the regular price. For example, a price at which the product was sold in the past is compared with a price at which the product is sold at present to identify whether the product is sold at the discounted price or at the regular price. At 109, upon identifying that the product is sold by the business entity at the regular price, a current inventory level (Q) of the product is retrieved from a product database associated with the business entity.

At 110, in response to retrieving the current inventory level (Q) of the product, a check may be performed to identify whether the current inventory level (Q) of the product is greater than or equal to a reorder inventory level of the product. The reorder inventory level is the level at which the business entity may issue a purchase order to replenish the inventory of the product. At 111, upon identifying that the current inventory level (Q) of the product is less than the reorder inventory level of the product, a demand forecast of the product is determined. In an embodiment, the demand forecast of the product may be determined based on the sensor data and the demonstration data. For example, a qualitative forecasting technique may be used to determine the demand forecast of the product based on the sensor data and the demonstration data. Personnel of the business entity may judge the demand forecast of the product based on the sensor data and the demonstration data. In another embodiment, a quantitative forecasting technique may be used to determine the demand forecast of the product based on historical sales data of the product, i.e., the quantity of the product sold by the business entity, past demand of the product and other factors influencing the demand of the product such as weather conditions, economic factors, geographical location of the business entity, etc. For example, quantitative forecasting techniques such as a casual methodology, a multiple regression technique, a time series analysis, etc., may be used to determine the demand forecast of the product. Alternatively, in some embodiments, the demand forecast of the product may be determined by using both the qualitative forecasting technique and the quantitative forecasting techniques. At 116, upon identifying that the current inventory level (Q) of the product is greater than or equal to the reorder inventory level of the product, the current inventory level of the product is communicated to the personnel of the business entity.

At 112, upon determining the demand forecast of the product, a purchase recommendation is generated and provided to the business entity for placing the purchase order to purchase the product based on the determined demand forecast of the product.

At 113, upon identifying that the product is sold by the business entity at the discounted price, the current inventory level (Q) of the product is retrieved from the product database. At 114, in response to retrieving the current inventory level (Q) of the product, a check may be performed to identify whether the current inventory level (Q) of the product is greater than zero or not. At 115, upon identifying that the current inventory level (Q) of the product is greater than zero, a discount recommendation is automatically generated and provided to the business entity to continue offering discounts on the product until the inventory level of the product is exhausted. At 116, upon identifying that the current inventory level (Q) of the product is not greater than zero, the current inventory level (Q) of the product is communicated to the business entity. In an embodiment, the current inventory level (Q) of the product may be presented on electronic mobile devices associated with the personnel of the business entity.

Upon identifying that the purchase conversion factor (C) for the product is less than the threshold value (Thₚ) defined for the product, a merchandise recommendation may be automatically generated and provided to the business entity for implementing one or more merchandising actions on the product. At 117 (FIG. 1C), the one or more merchandising actions may include recommending the business entity to offer discounts on the product, e.g., based on an amount of time the product is in the inventory. For example, if the product remains unsold in inventory for seven days, then a price of the product is reduced by 10%, and if the product remains unsold in inventory for fourteen days, then the price of the product is further reduced by 20%. At 118, the one or more merchandising actions may include recommending the business entity to trigger marketing campaign for the product. At 119, the one or more merchandising actions may include recommending the business entity to check a price of the product offered by competitors and effecting the change in the price of the product, if necessary.

In one embodiment, in a business entity such as a chain store, the one or more merchandising actions may include instructing the business entity for transferring the inventory of the product from the business entity to one or more other business entities in the same chain of stores based on purchase conversion factor of the product in the business entity, and the purchase conversion factors of the product in the one or more other business entities. For example, if a purchase conversion factor of product A displayed in a shopping area of a business entity A is 0.3, and a purchase conversion factor of the product A displayed in a shopping area of a business entity B is 0.8, then the business entity A may be instructed to transfer an inventory of product A from the business entity A to the business entity B. In another example, if the purchase conversion factor for a product is less than a threshold value defined for the product, then a merchandise recommendation is generated and provided to the business entity to transfer the inventory of the product from the business entity to a central warehouse. From there, the inventory of the product may be distributed to one or more other business entities, in response to a request from the one or more other business entities.

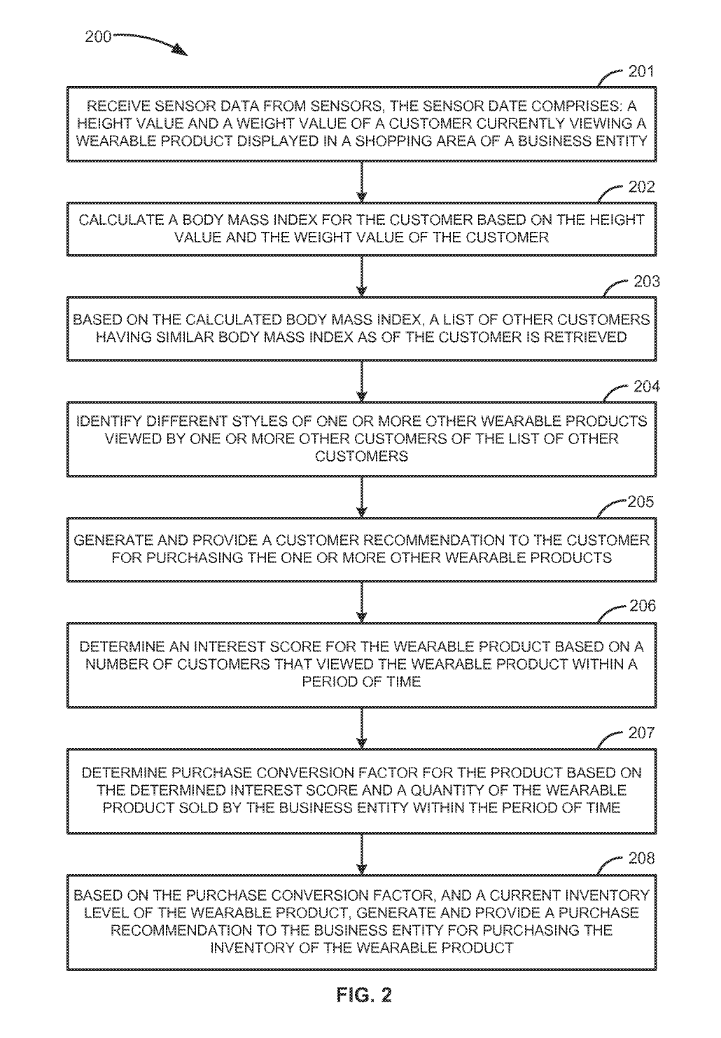

FIG. 2 is flow diagram illustrating process 200 to automatically generating and rendering recommendations to a customer viewing a wearable product, and to a business entity for managing an inventory of the wearable product, according to an embodiment. Examples of wearable product may include a trouser, a shirt, a waistcoat, a vest, etc. In an embodiment, the recommendation to the customer may be generated based on a body mass index of the customer viewing the wearable product, and sales of other wearable products. In another embodiment, the recommendation to the business entity may be generated based on an interest score of the wearable product and a quantity of the wearable product sold within a period of time.

At 201, sensor data is received from sensors configured to measure a height value and a weight value of a customer currently viewing the wearable product. In an embodiment, the sensors may be located in a certain region of the shopping area of the business entity. For example, sensors such as force sensors and pressure sensors may be installed on and/or wider the floor of a retail outlet for measuring the weight value and the height value of the customer.

At 202, a body mass index of the customer is calculated based on the height value and the weight value of the customer. At 203, based on the calculated body mass index of the customer, a list of other customers having similar body mass index as of the current customer is retrieved. For example, the difference between the body mass index of each customer of the other customers and a body mass index of the customer currently viewing the wearable product is less than a predefined value. In an embodiment, sensor data retrieved from the sensors associated with the other wearable products may be stored in a database, and the list of other customers having similar body mass index is retrieved from the database.

At 204, upon retrieving the list of other customers, different styles of one or more other wearable products viewed by each customer of the list of other customers are identified. In an embodiment, different styles of each other customer of the list of other customers are identified based on the sensor data retrieved from the sensors associated with the one or more other wearable products. For example, a sensor A may be installed for a wearable product A of style X and a sensor B may be installed for a wearable product A of style Y, then style of the viewed wearable product is identified based on the output of the sensor A and the sensor B. If the output of the sensor A is high, then it indicates that a customer viewed the wearable product A of style X.

In another embodiment, upon retrieving the list of other customers, different sizes of the one or more other wearable product viewed by each customer of the list of other customers are identified. For example, if body mass index of the customer currently viewing a wearable product of size X is 23.5, and the body mass index of other customer who viewed the different sizes (e.g., Y, Z, etc. of the same wearable product is 23.4, then different sizes (e.g., Y, Z, etc.) of the wearable product viewed by the other customer are identified.

At 205, in response to identifying the different sizes of the wearable product viewed by one or more other customers, the customer recommendation may be automatically generated and rendered to the customer for consideration. The customer recommendation may include the different styles of the one or more other wearable product viewed by each other customer of the list other customers. In another aspect, the customer recommendation may include the different sizes of the one or more other wearable products viewed by each other customer of the list of other customers. In an embodiment, the customer recommendation may be presented on an electronic devices associated with the customer. In another embodiment, the customer recommendation may be presented to the customer through a display monitor mounted near the wearable product. The display monitor may be connected to the computing device through some electrical or electronic means, such as an electrical cable or an infrared (IR) or Radio Frequency (RF) wireless connection. The computing device delivers this information to the display monitor, which in turn displays it to the customer. In some embodiments, the display monitor may be mounted to a shopping cart that the customer is using to carry the products. In an embodiment, other details related to the one or more other wearable products, such as, offers on the one or more other wearable products may be provided to the customer along with the customer recommendation.

At 206, in an embodiment, an interest score of the wearable product may be determined based on a number of customers that viewed the wearable product displayed in the shopping area of the business entity, within a period of time. In another embodiment, the interest score is determined based on a number of customers that viewed the wearable product within the period of time (also referred to as sensor data), and a number of times the wearable product is demonstrated to customers, e.g., that requested a product demonstration within the period of time (also referred to as demonstration data).

According to an embodiment, the sensor data received from the sensors further comprises the number of customers that viewed the wearable product within the period of time. The number of customers that viewed the wearable product within the period of time may be identified by a processor of a computing device, The output of the sensors (e.g., a detection signal) may be communicated to the computing device through a data communication network. The data communication network may include an electronic commnications network, such as the Internet, a local area network (“LAN”), a wide area network (“WAN”), a wireless local area network (“WLAN”) a cellular communications network or the like. In an embodiment, the computing device may be a server. When a customer is in the viewing region, the one or more sensors may detect the presence of the customer and produce the detection signal. A time period of the detection signal indicates the time spent by the customer in the viewing region. The time period of the detection signal is compared with a defined time. Based on the comparison, a footfall counter of the computing device is incremented, if the time period of the detection signal is greater than or equal to the defined time. In an embodiment, the business entity may be provided with an option to input the defined time. The footfall counter value at the end of the time period represents the number of the customers that viewed the wearable product within the period of time.

At 207, a purchase conversion factor for the wearable product is determined. The purchase conversion factor (C) for the wearable product is defined as a ratio of the quantity of the wearable product sold by the business entity within the period of time to the determined interest score for the wearable product. The purchase conversion factor for the wearable product is a measure of conversion of the customers' interest in the wearable product to sales of the wearable product. In an embodiment, the purchase conversion factor (C) for the wearable product may be compared with a threshold value (Thₚ) defined for the wearable product.

Upon identifying that the purchase conversion factor (C) for the wearable product is greater than or equal to the threshold value (Thₚ) defined for the wearable product, a current inventory level (Q) of the wearable product is retrieved from a wearable product database associated with the business entity. At 208, a purchase recommendation is automatically generated and rendered to the business entity, if the current inventory level (Q) of the wearable product is less than a reorder inventory level. The purchase recommendation may be generated based on a demand forecast of the wearable product. The reorder inventory level is the level at which the business entity may issue a purchase order to replenish the inventory of the wearable product.

In an embodiment, the threshold value (Thₚ) for the wearable product may be defined based on a cost of the wearable product and a type of the wearable product. In an embodiment, the demand forecast of the wearable product may be determined based on the sensor data and the demonstration data. For example, a qualitative forecasting technique may be used to determine the demand forecast of the wearable product based on the sensor data and the demonstration data. In another embodiment, the demand forecast of the wearable product may be determined based on historical sales data of the wearable product, e.g., the quantity of the wearable product sold by the business entity, past demand of the wearable product and other factors influencing the demand of the wearable product such as weather conditions, economic factors, geographical location of the business entity, etc. For example, quantitative forecasting techniques such as a casual methodology, a multiple regression technique, a time series analysis, etc., may be used to determine the demand forecast of the wearable product. Alternatively, in some embodiments, the demand forecast of the wearable product may be determined by using both the qualitative forecasting technique and the quantitative forecasting techniques.

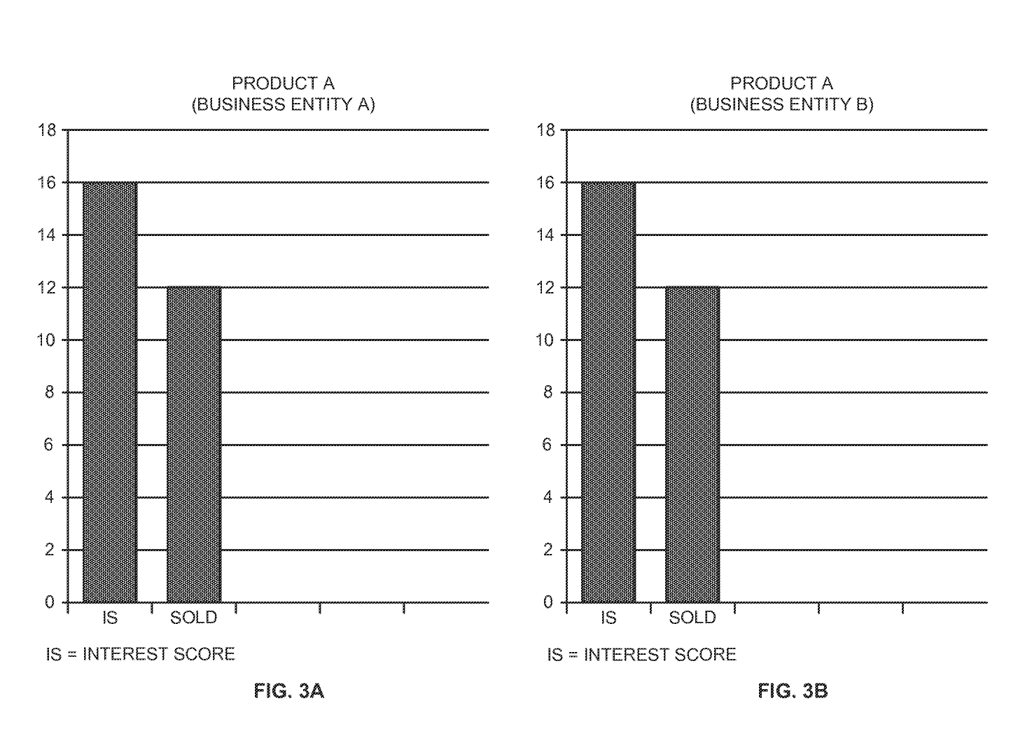

FIG. 3A and FIG. 3B are charts illustrating an exemplary interest maps generated for product A of a business entity A, and product A of a business entity B, respectively, according to an embodiment. An interest map for the product A displayed in a shopping area of the business entity A may be generated based on an interest score and sales data for the product A of the business entity A. The interest score of the product A of the business entity A may be determined by retrieving sensor data and demonstration data related to the product A. The sensor data represent a number of customers that viewed the product A displayed in the shopping area of the business entity A, within a period of time. The demonstration data represent a number of times the product A may be demonstrated in the shopping area of the business entity A within the period of time. The interest score for the product A of the business entity A may be determined as a sum of weighted sensor data of the product A and weighted demonstration data of the product A. The weighted sensor data of the product A may be a product of a first weighting factor and the sensor data of product A, and the weighted demonstration data of the product A may be a product of a second weighting factor and the demonstration data of the product A.

Visual representation of a comparison between the interest score and the sales data of the product A of the business entity A may be represented as the interest map for the product A (FIG. 3A). The interest map may be either in graphical form (bar graphs, pie charts, line charts or stacked bar charts, etc.) or anon-graphical form (text, tabular data, (etc.). For example, comparison of the interest score and the sales data of the product A may be represented in the form of a bar graph showing rectangular bars representing interest score of the product A, and a quantity of the product A sold by the business entity A (e.g., sales data), within the period of time, as shown in the FIG. 3A.

Similarly, an interest map for the product A of the business entity B may be generated based on an interest score and sales data of the product A of the business entity B. Visual representation of a comparison between the interest score and the sales data of the product A of the business entity B may be represented in the form of bar graph showing rectangular bars representing interest score of the product A, and a quantity of the product A sold (e.g., sales data) by the business entity B, within the period of time, as shown in FIG. 3B.

In an embodiment, the generated interest maps for the product A of the business entity A, and product A of the business entity B may be rendered to personnel of the business entities A and B, respectively, for easily identifying potential demand for the product A in the business entities A and B, in an embodiment, based on the rendered interest maps, the personnel of the business entity A and/or the business entity B may take an appropriate action for managing the inventory of product A in the business entities A and B. For example, the business entity A may consider moving some or all of the inventory of the product A from business entity A to business entity B, where business entities A and B belongs to same retail chain.

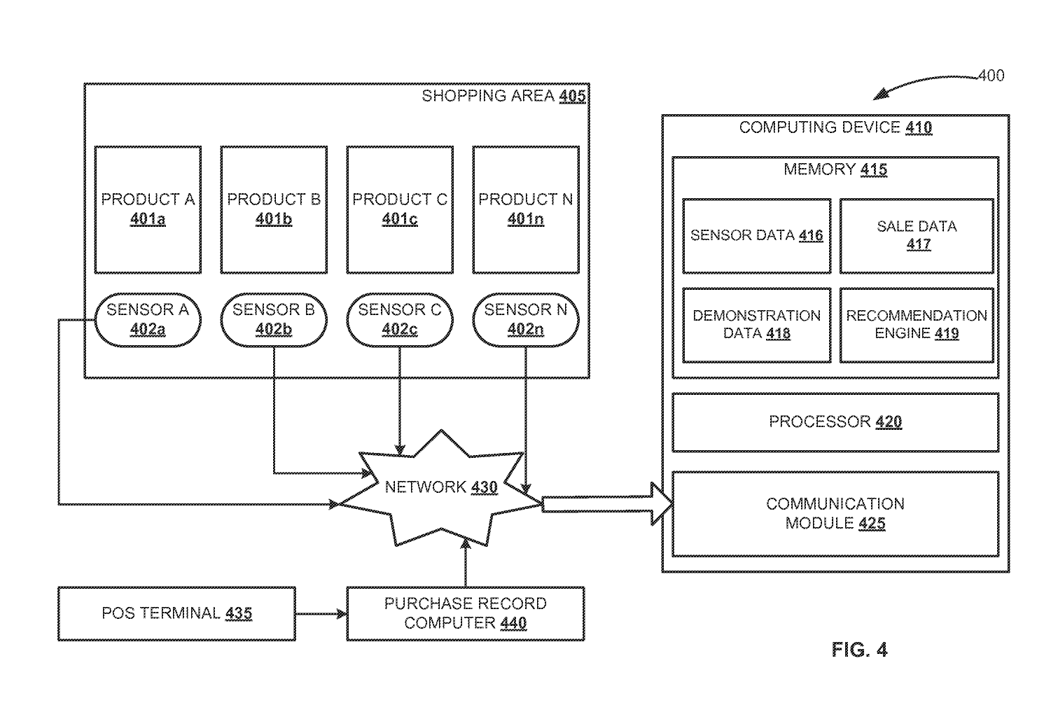

FIG. 4 is a block diagram of exemplary system 400 for automatically generating recommendations to manage an inventory of products, according to an embodiment. With reference to FIG. 4, the system may include computing device 410. The computing device 410 may be one or more computers configured to perform one or more operations consistent with the disclosed embodiments. The computing device 410 may comprise processor 420 to handle the overall operation of the computing device 410 and its associated components, including communications module 425 and memory 415, which could be a random-access memory (RAM) and/or a read-only memory (ROM). The memory 415 may be operatively connected to the processor 420. As shown in FIG. 4, the memory 415 may store sensor data 446, demonstration data 448, sales data 417 and recommendation engine 419. The recommendation engine 419 may be implemented using any one of a number of programming languages such as, for example, C, C++, JAVA, or other programming languages. The recommendation engine 419 may be configured to automatically generate recommendations for managing the inventory of the products based on the sensor data 416, the demonstration data 418, and the sales data 417, as described in the flow diagram 100.

The sensor data 416 may be retrieved by the processor 420 over a network, e.g., network 430, from sensors A to N (402a to 402n) associated with products A to N (401a to 401n), respectively, displayed in a shopping area of a business entity. The sensors (402a to 402n) may be force sensors, load sensors, pressure sensors, touch sensors, proximity sensors, optical sensors, heat map sensors, etc.

In an embodiment, the sensors (402a to 402n) may be located in a certain region of the shopping area of the business entity. For example, sensors such as optical sensors and proximity sensors may be placed along the line of vision of the product and a customer. In another example, sensors such as heal map sensors may be installed in floors or ceilings to literally track a “heat map” of where customers are present in a shopping area of a retail outlet. Heat maps can be constructed to watch footfall patterns of the customers.

In an embodiment, sensors (402a to 402n) may detect the presence of customers in viewing regions relative to the products A to N (401a to 401n), displayed in the shopping area. The term “viewing region” as used herein refers to a spatial location defined in relation to the product being viewed. For example, for a particular product placed on a shelf in a shopping area of a retail outlet, the region in front of the product having defined boundaries is the viewing region relative to that particular product. Sensors (402a to 402n) may be tuned or adapted to detect the presence of customers in respective viewing regions and correlate this information to the products associated with the respective viewing regions.

The sales data 417 may be retrieved by the processor 420, from a sales record system having plurality of Point-of-Sale (POS) terminals 435 and sales record computer 440. POS terminal 435 may be configured to identify and record purchased product. The POS terminal 435 typically includes a scanner and cash register, but may include other components configured to identify and record purchased product. These purchase records are sent as the sales data 417. The demonstration data 418 may be retrieved by the processor 420, e.g., from plurality of portable electronic devices operated by one or more product demonstrators demonstrating the products in the shopping area 405 of a business entity. The processor 420 then processes the sensor data 416, the demonstration data 418, and the sales data 417 using the one or more programs of recommendation engine 419 stored in the memory 415 to perform the process described with reference to FIG. 1. Further, the processor 4:20 can transmit the data between other components of the system.

The computing device 410 typically includes a variety of computer readable media. The computer readable media may be any available media that may be accessed by the server and include both volatile and nonvolatile media, removable and non-removable media (not shown in the FIG. 4). The computing device may be connected to a network through a network interface or adapter in the communications module 425. When used in a WAN networking environment, the computing device 410 may include a modem in the communications module 425 or other means for establishing communications over the WAN, such as the Internet or other type of computer network.

The system may further include a media reader to read the instructions from the computer readable storage medium and store the instructions in storage or in RAM. For example, the computer readable storage medium includes executable instructions for performing operations including, but not limited to, receiving sensor data from one or more sensors; processing the sensor data to generate a viewed data, wherein the viewed data represents a number of customers that viewed a product within a period of time, wherein the product is displayed within a shopping area of a business entity; receiving demonstration data from one or more product demonstrators, wherein the demonstration data represents a number of times the product is demonstrated in the shopping area by the one or more product demonstrators to customers that requested a product demonstration, within the period of time; determining an interest score for the product based on the sensor data 416 and the demonstration data 418, wherein the interest score is indicative of the customers' interest in the product; retrieving sales data associated with one or more products sold by a business entity, wherein the sales data represents a quantity of a product purchased within a period of time; and based on the interest score and the sales data, automatically generating at least one of the recommendations for managing an inventory of the product.

The computing device 410 may also comprise a display. The display may be any of various types such as LCD (liquid crystal display), a CRT (cathode ray tube) display, etc.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

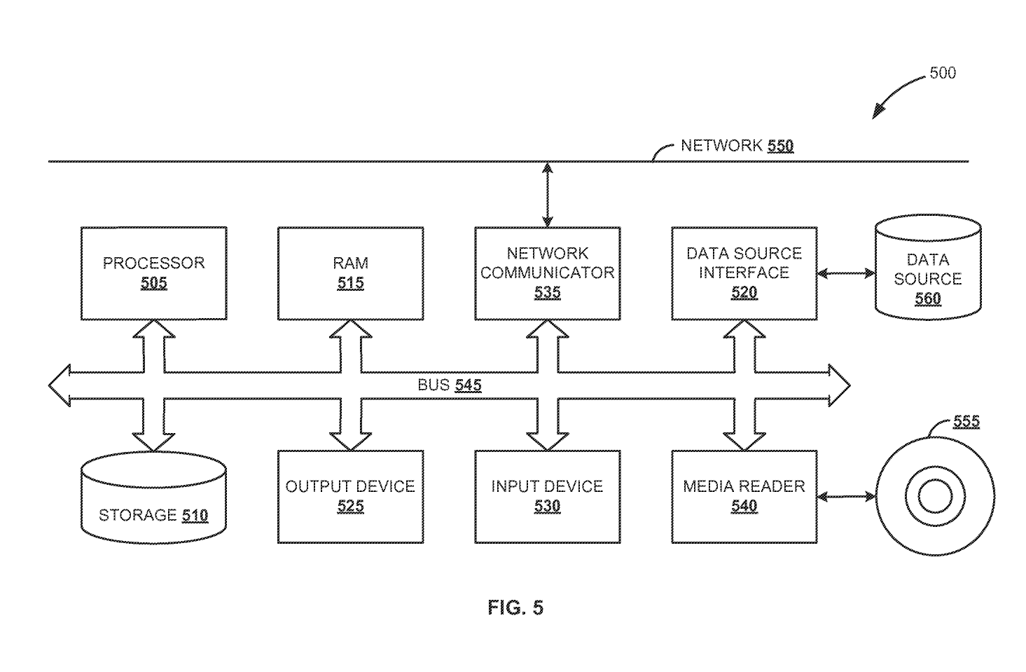

FIG. 5 is a block diagram of an exemplary computer system 500. The computer system 500 includes a processor 505 that executes software instructions or code stored on a computer readable storage medium 555 to perform in the above-illustrated methods. The processor 505 can include a plurality of cores. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, all of the data required for processing may be stored in the RAM 515. The stored instructions may be further compiled to generate other representations of the instructions and dynamically stored in the RAM 515. The processor 505 reads instructions from the RAM 515 and performs the actions as instructed. According to one embodiment, the computer system 500 further includes an output device 525 (e.g., a display) to provide at least some of the results of the execution as output, including, but not limited to, visual information to users and an input device 530 to provide a user or other device with an option for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 720 to access data source 560. The data source 560 can be accessed via one or more abstraction layers implemented in hardware or software. For example, the data source 560 may be accessed by network 550. in some embodiments the data source 560 may be accessed via an abstraction layer, such as, a semantic layer.

A data source 560 is an information resource. Data sources 560 include sources of data that enable data storage and retrieval. Data sources 560 may include databases, such as, relational, transactional, hierarchical, and multi-dimensional (e.g., OLAP), object oriented databases, and the like. Further data sources 560 include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source 560 accessible through an established protocol, such as, Open Database Connectivity (ODBC), produced by an underlying software system (e.g., Enterprise Resource Planning (ERP) system), and the like. Data sources 560 may also include a data source 560 where the data is not tangibly stored or otherwise ephemeral such as data streams, the broadcast data, and the like. These data sources 560 can include associated data foundations, semantic layers, management systems, security systems and so on.

In the above description, numerous specific details are set forth to provide a thorough understanding of embodiments. One skilled in the relevant art will recognize, however, that the embodiments can be practiced without one or more of the specific details, or with other methods, components, techniques, etc. In other instances, well-known operations or structures are not shown or described in detail.

Although the processes illustrated and described herein include a series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

1. A computer implemented method to automatically generating recommendations, the method comprising:
receiving sensor data from one or more sensors, the sensor data represent a number of customers that viewed a product within a period of time, wherein the product is displayed in a shopping area of a business entity;
receiving demonstration data representing a number of times the product is demonstrated in the shopping area by one or more product demonstrators to customers within the period of time;
determining an interest score for the product based on the sensor data and the demonstration data, wherein the interest score is indicative of interest shown by customers towards the product;
retrieving sales data associated with the product sold by the business entity, wherein the sales data represents a quantity of the product sold within the period of time by the business entity; and
based on the determined interest score and the sales data, automatically generating the recommendations for managing an inventory of the product.

2. The method as claimed in claim 1, wherein the determining the interest score for the product comprises:
assigning a first weighting factor to the sensor data and a second weighting factor to the demonstration data.

3. The method as claimed in claim 1, wherein the generating at least one of the recommendations for managing the inventory of the product comprises:
determining a purchase conversion factor for the product as a ratio of the quantity of the product sold by the business entity within the period of time to the determined interest score for the product;
comparing the purchase conversion factor for the product with a threshold value assigned based on a type of the product and a cost of the product; and
based on the comparison, generating the at least one of the recommendations, wherein the recommendations comprise: a purchase recommendation a discount recommendation, and a merchandise recommendation.

4. The method as claimed in claim 3 further comprising:
retrieving a current inventory level of the product when the purchase conversion factor of the product is greater than or equal to the threshold value;
identifying that the current inventory level of the product is less than or equal to a reorder inventory level of the product;
in response to the identifying, determining a demand forecast for the product based on the sensor data and the demonstration data; and
automatically generating the purchase recommendation for placing a purchase order based on the determined demand forecast.

5. The method as claimed in claim 3 further comprising:
retrieving a current inventory level of the product when the purchase conversion factor of the product is greater than or equal to the threshold value;
identifying that the product is sold by the business entity at a discounted price;
identifying that the current inventory level of the product is greater than zero; and
automatically generating the discount recommendation to continue offering discounts on the product.

6. The method as claimed in claim 3 further comprising:
identifying that the purchase conversion factor of the product is less than the threshold value defined for the product; and
in response to the identifying, automatically generating the merchandise recommendation for implementing one or more merchandising actions on the product, wherein the one or more merchandising actions are selected from a group consisting of: offering a discount on the product based on an amount of time the product is in the inventory, triggering a marketing campaign for the product, and effecting a change in a price of the product.

7. The method as claimed in claim 3 further comprising:
identifying that the purchase conversion factor of the product is less than the threshold value defined for the product; and
in response to the identifying, automatically generating the merchandise recommendation for implementing one or more merchandising actions on the product, wherein the one or more merchandise actions include transferring the inventory of the product from the business entity to one or more other business entities based on a demand of the product in the one or more other business entities.

8. The method as claimed in claim 1 further comprising:
generating one or more interest maps for the product based on the determined interest score and the sales data.

9. A computer implemented method to automatically generating recommendations, the method comprising:
receiving sensor data from sensors, the sensor data comprising a height value and a weight value of a customer currently viewing a wearable product displayed in a shopping area of a business entity;
based on the height value and the weight value of the customer, retrieving a list of other customers having similar body mass index as of the customer, wherein the body mass index of the customer is calculated based on the height value and the weight value of the customer;
identifying different styles of one or more other wearable products viewed by each other customer of the list of other customers; and
in response to the identifying, automatically generating and providing the recommendations including a recommendation to the customer for purchasing different styles of the one or more other wearable products.

10. The method as claimed in claim 9 further comprising:
determining an interest score of the wearable product based on a number of customers that viewed the wearable product within a period of time, and a number of times the wearable product is demonstrated in the shopping area by one or more product demonstrators to customers within the period of time;
determining a purchase conversion factor for the wearable product as a ratio of the quantity of the wearable product sold by the business entity within the period of time to the determined interest score for the wearable product;
comparing the purchase conversion factor for the wearable product with a threshold value assigned based on a type of the wearable product and a cost of the wearable product; and
based on the comparison, automatically generating and providing the recommendations including a purchase recommendation, a discount recommendation, and a merchandise recommendation.

11. The method as claimed in claim 10 further comprising:
retrieving a current inventory level of the wearable product when the purchase conversion factor of the wearable product is greater than or equal to the threshold value;
identifying that the current inventory level of the wearable product is less than or equal to a reorder inventory level of the wearable product;
in response to the identifying, determining a demand forecast for the wearable product; and
automatically generating the purchase recommendation for placing the purchase order based on the determined demand forecast.

12. The method as claimed in claim 10 further comprising:
retrieving a current inventory level of the wearable product when the purchase conversion factor of the wearable product is greater than or equal to the threshold value;
identifying that the wearable product is sold by the business entity at a discounted price;
identifying that the current inventory level of the wearable product is greater than zero; and
automatically generating the discount recommendation to continue offering discounts on the wearable product.

13. The method as claimed in claim 10 further comprising:
identifying that the purchase conversion factor of the wearable product is less than the threshold value defined for the wearable product; and
in response to the identifying, automatically generating the merchandise recommendation for implementing one or more merchandising actions on the wearable product, wherein the one or more merchandising actions are selected from a group consisting of: offering a discount on the wearable product based on an amount of time the wearable product is in the inventory, triggering a marketing campaign for the wearable product, and effecting a change in a price of the wearable product.

14. The method as claimed in claim 10 further comprising:
identifying that the purchase conversion factor of the wearable product is less than the threshold value defined for the wearable product; and
in response to the identifying, automatically generating the merchandise recommendation for implementing one or more merchandising actions on the wearable product, wherein the one or more merchandise actions include transferring the inventory of the wearable product from the business entity to one or more other business entities based on a demand of the wearable product in the one or more other business entities.

15. An article of manufacture including a non-transitory computer readable storage medium to tangibly store instructions, which when executed by a computer, cause the computer to:
receive sensor data from one or more sensors, the sensor data represent a number of customers that viewed a product within a period of time, wherein the product is displayed in a shopping area of a business entity;
receive demonstration data representing a number of times the product is demonstrated in the shopping area by one or more product demonstrators to customers within the period of time;
determine an interest score for the product based on the sensor data and the demonstration data, wherein the interest score is indicative of interest shown by customers towards the product;
retrieve sales data associated with the product sold by the business entity, wherein the sales data represents a quantity of the product sold within the period of time by the business entity; and
based on the determined interest score and the sales data, automatically generate the recommendations for managing an inventory of the product.

16. The article of manufacture as claimed in claim 15, further comprising instructions which when executed by the computer further the cause the computer to:
assign a first weighting factor to the sensor data and a second weighting factor to the demonstration data.

17. The article of manufacture as claimed in claim 15, further comprising instructions which when executed by the computer further the cause the computer to:
determine a purchase conversion factor for the product as a ratio of the quantity of the product sold by the business entity within the period of time to the determined interest score for the product;
compare the purchase conversion factor for the product with a threshold value assigned based on a type of the product and a cost of the product; and
based on the comparison, generate the at least one of the recommendations, wherein the recommendations comprise: a purchase recommendation, a discount recommendation, and a merchandise recommendation.

18. The article of manufacture as claimed in claim 17, further comprising instructions which when executed by the computer further the cause the computer to:
retrieve a current inventory level of the product when the purchase conversion factor of the product is greater than or equal to the threshold value;
identify that the current inventory level of the product is less than or equal to a reorder inventory level of the product;
in response to the identifying, determining a demand forecast for the product based on the sensor data and the demonstration data; and
automatically generate the purchase recommendation for placing a purchase order based on the determined demand forecast.

19. The article of manufacture as claimed in claim 17, further comprising instructions which when executed by the computer further the cause the computer to:
retrieve a current inventory level of the product when the purchase conversion factor of the product is greater than or equal to the threshold value;
identify that the product is sold by the business entity at a discounted price;
identify that the current inventory level of the product is greater than zero; and
automatically generate the discount recommendation to continue offering discounts on the product.

20. The article of manufacture as claimed in claim 17, further comprising instructions which when executed by the computer further the cause the computer to:
identify that the purchase conversion factor of the product is less than the threshold value defined for the product; and
in response to the identifying, automatically generate the merchandise recommendation for implementing one or more merchandising actions on the product, wherein the one or more merchandising actions are selected from a group consisting of:
offering a discount on the product based on an amount of time the product is in the inventory, triggering a marketing campaign for the product, and effecting a change in a price of the product.

21. The article of manufacture as claimed in claim 17, further comprising instructions which when executed by the computer further the cause the computer to:
identify that the purchase conversion factor of the product is less than the threshold value defined for the product; and
in response to the identifying, automatically generate the merchandise recommendation for implementing one or more merchandising actions on the product, wherein the one or more merchandise actions include transferring the inventory of the product from the business entity to one or more other business entities based on a demand of the product in the one or more other business entities.

22. The article of manufacture as claimed in claim 15, further comprising instructions which when executed by the computer further the cause the computer to:
generate one or more interest maps for the wearable product based on the interest score and the sales data.

23. A computer system for automatically generating recommendations, the computer system comprising:
a memory to store the program code;
a processor communicatively coupled to the memory, the processor configured to execute the program code to:
receive sensor data liom one or more sensors, the sensor data represent a number of customers that viewed a product within a period of time, wherein the product is displayed in a shopping area of a business entity;
receive demonstration data representing a number of times the product is demonstrated in the shopping area by one or more product demonstrators to customers within the period of time;
determine an interest score for the product based on the sensor data and the demonstration data, wherein the interest score is indicative of interest shown by customers towards the product;
retrieve sales data associated with the product sold by the business entity, wherein the sales data represents a quantity of the product sold within the period of time by the business entity; and
based on the determined interest score and the sales data, automatically generate the recommendations for managing an inventory of the product.

24. The computer system as claimed in claim 23, wherein the one or more sensors configured to detect presence of customers in a viewing region, wherein the viewing region is a spatial location defined in relation to the product.

25. The computer system as claimed in claim 23, wherein the sales data is retrieved from a sales record system of the business entity, wherein the sales record system comprises a plurality of Point-of-Sale (POS) terminals coupled to a sales record computer.
